(19) United States
(12) Patent Application Publication
(10) Pub. No.: US 2026/0005922 A1
(43) Pub. Date: Jan. 1, 2026

(54) APPARATUS, SYSTEM, AND METHOD FOR REDUCING COSTS AND POWER CONSUMPTION IN NETWORK FABRICS

(71) Applicant: Juniper Networks, Inc., Sunnyvale, CA (US)

(72) Inventors: Muhammad Sagarwala, Los Gatos, CA (US); Gurmeet Singh, Bangalore (IN); Chi Chen Ho, Pleasanton, CA (US)

(21) Appl. No.: 19/245,928

(22) Filed: Jun. 23, 2025

(30) Foreign Application Priority Data
Jun. 29, 2024 (IN) 202411049960

(51) Int. Cl. H04L 41/0893; H04L 45/02; H04L 45/125

(52) U.S. Cl. CPC H04L 41/0893; H04L 45/02; H04L 45/125

(57) ABSTRACT

A disclosed system for reducing costs and power consumption in network fabrics may include (1) a network device that is equipped with a certain number of connectors and comprises circuitry that facilitates connectivity across the connectors, (2) a set of fabric cards communicatively coupled to a first subset of the connectors, and (3) a set of inactive loopback cards communicatively coupled to a second subset of the connectors, wherein the connectors collectively facilitate connectivity from all the fabric cards and all the inactive loopback cards to the circuitry. Various other apparatuses, systems, and methods are also disclosed.

### CROSS REFERENCE TO RELATED APPLICATION

This application claims the benefit of Indian Provisional Application No. 202411049960 filed June 29, 2024, the disclosure of which is incorporated in its entirety by this reference.

### SUMMARY

As will be described in greater detail below, the instant disclosure generally relates to reducing costs and power consumption in network fabrics. In one example, a system for accomplishing such a task may include (1) a network device that is equipped with a certain number of connectors and comprises circuitry that facilitates connectivity across the connectors, (2) a set of fabric cards communicatively coupled to a first subset of the connectors, and (3) a set of inactive loopback cards communicatively coupled to a second subset of the connectors, wherein the connectors collectively facilitate connectivity from all the fabric cards and all the inactive loopback cards to the circuitry.

Similarly, a corresponding apparatus may include (1) a line card that is equipped with a certain number of connectors and comprises at least one application-specific integrated circuit (ASIC) that facilitates connectivity across the connectors, (2) a set of fabric cards communicatively coupled to a first subset of the connectors, and (3) a set of inactive loopback cards communicatively coupled to a second subset of the connectors, wherein the connectors collectively facilitate connectivity from all the fabric cards and all the inactive loopback cards to the ASIC.

A corresponding method may include (1) equipping a network device with a certain number of connectors and circuitry that facilitates connectivity across a set of connectors, (2) communicatively coupling a set of fabric cards to a first subset of the connectors, and (3) communicatively coupling a set of inactive loopback cards to a second subset of the connectors such that the connectors collectively facilitate connectivity from all the fabric cards and all the inactive loopback cards to the circuitry.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an exemplary system for reducing costs and power consumption in network fabrics according to one or more embodiments of this disclosure.

FIG. 2 is an illustration of an exemplary apparatus for reducing costs and power consumption in network fabrics according to one or more embodiments of this disclosure.

FIG. 3 is an illustration of an exemplary system for reducing costs and power consumption in network fabrics according to one or more embodiments of this disclosure.

FIG. 4 is an illustration of an exemplary implementation of an apparatus for reducing costs and power consumption in network fabrics according to one or more embodiments of this disclosure.

FIG. 5 is an illustration of an exemplary implementation of a system for reducing costs and power consumption in network fabrics according to one or more embodiments of this disclosure.

FIG. 6 is a flow diagram of an exemplary method for reducing costs and power consumption in network fabrics according to one or more embodiments of this disclosure.

FIG. 7 is a block diagram of an exemplary computing system capable of implementing and/or being used in connection with one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure describes various apparatuses, systems, and methods for reducing costs and power consumption in network fabrics. As will be explained in greater detail below, embodiments of the present disclosure may include and/or involve configurations and/or techniques that enable network fabrics to run, operate, and/or function efficiently with the minimum number of fabric cards needed to achieve a certain backplane bandwidth. In some examples, this backplane bandwidth may be calculated according to the configuration requirements of one or more line cards included in the network fabrics. In one example, the network fabrics may include and/or involve one or more loopback cards installed in place of one or more unused slots intended and/or dimensioned for fabric or line cards. In this example, the loopback cards may facilitate and/or support routing signals and/or traffic to or through other fabric cards installed in the network fabrics.

As a specific example, a network fabric may include and/or represent a telecommunications chassis equipped with a low-density line card and slots for 9 fabric cards. In one example, 3 fabric cards may be installed in 3 of the 9 fabric card slots. In this example, 6 loopback cards may be installed in the remaining 6 fabric card slots. In certain implementations, the low-density line card may be configured to route remote loopback signals to and/or through one or more of the 3 operational fabrics cards. As a result, this configuration and/or technique may reduce the number of necessary fabric cards from 9 down to 3, thereby reducing the costs and power consumption of this network fabric.

As another example, a network fabric may include and/or represent a telecommunications chassis equipped with slots for 8 line cards and slots for 8 fabric cards. In one example, 4 fabric cards may be installed in 4 of the 8 fabric card slots. In this example, 4 loopback and/or passthrough cards may be installed in the remaining 4 fabric card slots.

In one example, 4 line cards may be installed in 4 of the 8 line card slots. In this example, 4 loopback and/or passthrough devices may be installed in the remaining 4 line card slots. In certain implementations, the loopback and/or passthrough cards and/or devices may be configured to route loopback signals to the fabric cards and/or line cards. As a result, this configuration and/or technique may decrease the number of necessary fabric cards and/or line cards from 8 down to 4, thereby reducing the costs and power consumption of this network fabric.

As a specific example, a network fabric may effectively route backplane fabric connections from an active line card to an unused line card slot. For example, the network fabric may route connections from line card slot 0 routed to line card slot 4. In this example, line card slot 4 may route backplane connections belonging to line card slot 0 to and/or through active fabric cards. In this network fabric and/or configuration, 4 high-density line cards may route all their fabric signals to and/or through 4 fabric cards to achieve line rate. In certain implementations, the network fabric may also include and/or involve retiming devices on the line cards to meet and/or satisfy certain signal-integrity standards and/or requirements.

In some examples, a network fabric may include and/or involve a chassis with capacity to accommodate 8 fabric card slots. In one example, the chassis may be deployed and/or configured to run, operate, and/or function as a 4-slot chassis despite its capacity to accommodate 8 fabric cards. In this configuration, the network fabric may enable users and/or administrators to begin operations with low-density deployments or line cards and then move and/or evolve to high-density deployments or line cards over the span of several years, thereby saving on the costs of goods and/or power at the outset of operations.

In some examples, a network fabric may include and/or involve a low-density line card equipped with a single application-specific integrated circuit (ASIC) for backplane connectivity. In this example, the single ASIC line card may include and/or represent 9 fabric card connectors, namely FCCO, FCC1, FCC2, FCC3, FCC4, FCC5, FCC6, FCC7, and FCC8. In this example, fabric card connectors FCCO, FCC1, and FCC2 may be communicatively coupled to active fabric cards FCO, FC1, and FC2, respectively, while fabric card connectors FCC3, FCC4, FCC5, FCC6, FCC7, and FCC8 may be communicatively coupled to inactive loopback cards LBC3, LBC4, LBC5, LBC6, LBC7, and LBC 8, respectively. In this example, loopback cards LBC3-LBC8 may merely return and/or loop the signals back to fabric card connectors FCC3-FCC8, respectively. In certain implementations, each of fabric card connectors FCCO-FCC8 may be communicatively coupled to the ASIC of the line card.

Continuing with this example, fabric card connectors FCC3 and FCC6 may pass and/or forward signals from loopback cards LBC3 and LBC6, respectively, to fabric card FCO via fabric card connector FCCO. Additionally or alternatively, fabric card connectors FCC4 and FCC7 may pass and/or forward signals from loopback cards LBC4 and LBC7, respectively, to fabric card FC1 via fabric card connector FCC1. Similarly, fabric card connectors FCC5 and FCC8 may pass and/or forward signals from loopback cards LBC5 and LBC8, respectively, to fabric card FC2 via fabric card connector FCC2. In certain implementations, some signals may travel and/or traverse in the opposite direction through the same paths from fabric cards FCO-FC2 to the ASIC via loopback cards LBC3-LBC8.

In some examples, a network fabric may include and/or involve a high-density line card equipped with 3 ASICs for backplane connectivity installed into slot 0 of a chassis as well as a loopback line card installed into slot 4 of the chassis. In this example, the 3-ASIC line card may include and/or represent 8 fabric card connectors, namely FCCO, FCC1, FCC2, FCC3, FCC4, FCC5, FCC6, and FCC7. In this example, fabric card connectors FCCO, FCC1, FCC2, and FCC3 may be communicatively coupled to the loopback line card via active fabric cards FCO, FC1, FC2, and FC4, respectively, while fabric card connectors FCC4, FCC5, FCC6, and FCC7 may be communicatively coupled to the inactive loopback line card via inactive fabric cards LFC4, LFC5, LFC6, and LFC7. In this example, the inactive loopback line card may return and/or loop the signals from the 3-ASIC line card to fabric cards FCO, FC1, FC2, and FC3 via loopback fabric cards LFC4, LFC5, LFC6, and LFC7, respectively. In certain implementations, each of fabric card connectors FCCO-FCC7 may be communicatively coupled to each of the 3 ASICs of the line card.

Continuing with this example, loopback fabric cards LFC4-LFC7 may pass and/or forward signals from the 3-ASIC line card to the inactive loopback line via fabric card connectors FCC4-FCC7 and inactive loopback fabric cards LFC4-LFC7. In this example, the inactive loopback line card may then pass and/or forward those signals to fabric cards FCO-FC3 via internal connections. In certain implementations, some signals may travel and/or traverse in the opposite direction through the same paths from fabric cards FCO-FC3 to the 3-ASIC line card via the inactive loopback line card and/or loopback fabric cards LFC4-LFC7.

In some examples, a network fabric may include and/or represent a chassis equipped with 8 slots for line cards and/or 8 slots for fabric cards. In one example, active line cards may be communicatively coupled to 4 of the 8 line card slots, while inactive loopback line cards may be communicatively coupled to the other 4 line card slots. Additionally or alternatively, active fabric cards may be installed in 4 of the 8 fabric card slots, while inactive loopback fabric cards may be installed in the other 4 fabric card slots. In this example, each of the active line cards and the inactive loopback line cards may be communicatively coupled to each of the active fabric cards and inactive loopback fabric cards. In this configuration, the inactive loopback fabric cards may relay signals and/or traffic from the active line cards to the inactive loopback line cards. The inactive loopback line cards may then relay such signals and/or traffic from the inactive loopback fabric cards to the active fabric cards.

In one example, a high-density line card may be equipped with a number of components (such as packet-forwarding engines and/or connectors) that satisfies and/or exceeds an upper threshold. In another example, a medium-density line card may be equipped with a number of components that satisfies one or more thresholds (e.g., above a lower threshold but below an upper threshold). In an additional example, a low-density line card may be equipped with a number of components that satisfies and/or remains below a lower threshold.

As a specific example, a high-density line card may include and/or represent three or more packet-forwarding engines and/or application-specific integrated circuits (ASICs). Additionally or alternatively, a high-density line card may include and/or represent nine or more connectors and/or connectors. In another example, a medium-density line card may include and/or represent two packet-forwarding engines and/or ASICs. Additionally or alternatively, a medium-density line card may include and/or represent six connectors and/or connectors. In an additional example, a low-density line card may include and/or represent one packet-forwarding engine and/or ASIC. Additionally or alternatively, a low-density line card may include and/or represent three or less connectors and/or connectors.

In some examples, line cards may be installed and/or inserted in slots of a router chassis. In one example, line cards may represent part of and/or be associated with a switch fabric and/or network fabric included in a system. Additionally or alternatively, line cards may be hot-insertable and/or hot-removable such that insertion and/or removal is accomplished without powering off and/or disrupting the corresponding router functions of the system. In certain implementations, line cards may each include and/or represent a single assembly that combines one or more packet-forwarding engines and one or more connectors or connectors.

In some examples, a network fabric may include and/or represent a Clos topology and/or a spine-leaf topology with multiple stages corresponding to different topological roles, such as spine, leaf, and/or top-of-fabric (ToF). For example, a network fabric may include and/or represent a ToF stage (e.g., ToF nodes interconnected and/or communicatively coupled to a spine stage that includes spine nodes). In this example, the spine stage of the network fabric may also be interconnected and/or communicatively coupled to a leaf stage (e.g., leaf nodes).

In some examples, a network fabric may constitute and/or represent a topology in which the various nodes have discovered and/or implemented their proper roles. For example, a network fabric may include and/or represent a Clos topology in which one or more of the various nodes have yet to discover and/or implement their proper roles. In this example, the network fabric may include and/or represent the same Clos topology after all the various nodes have discovered and/or implemented their proper roles.

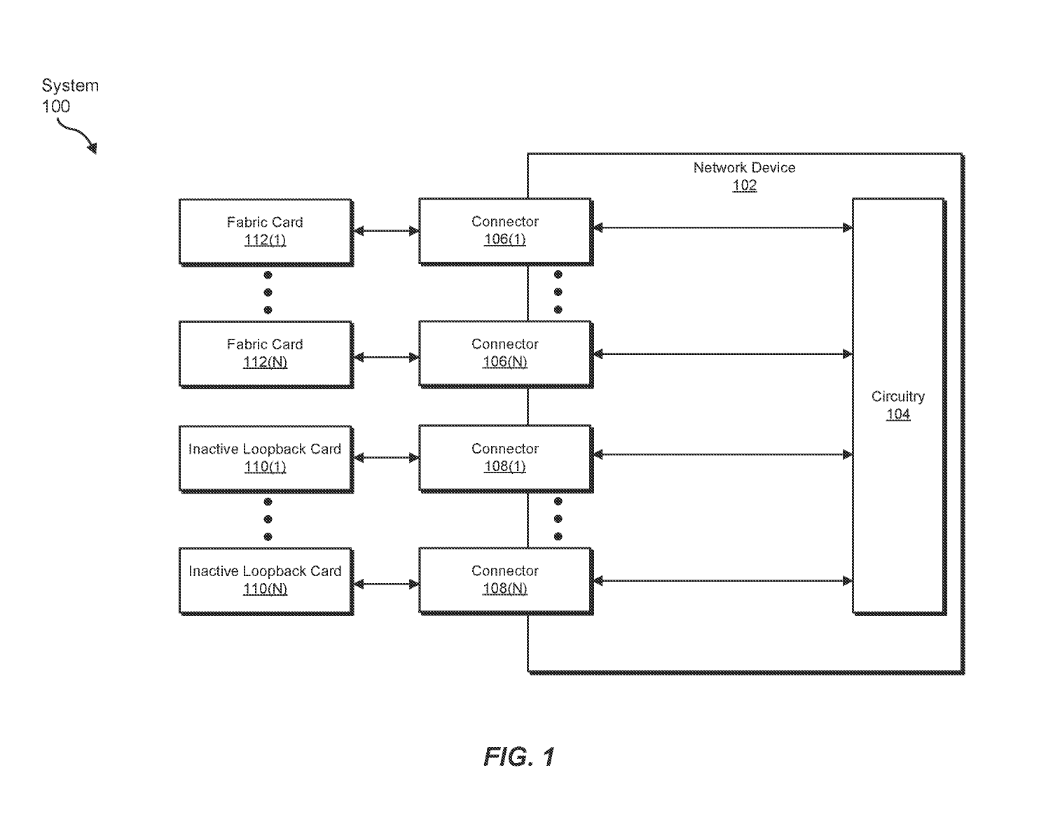

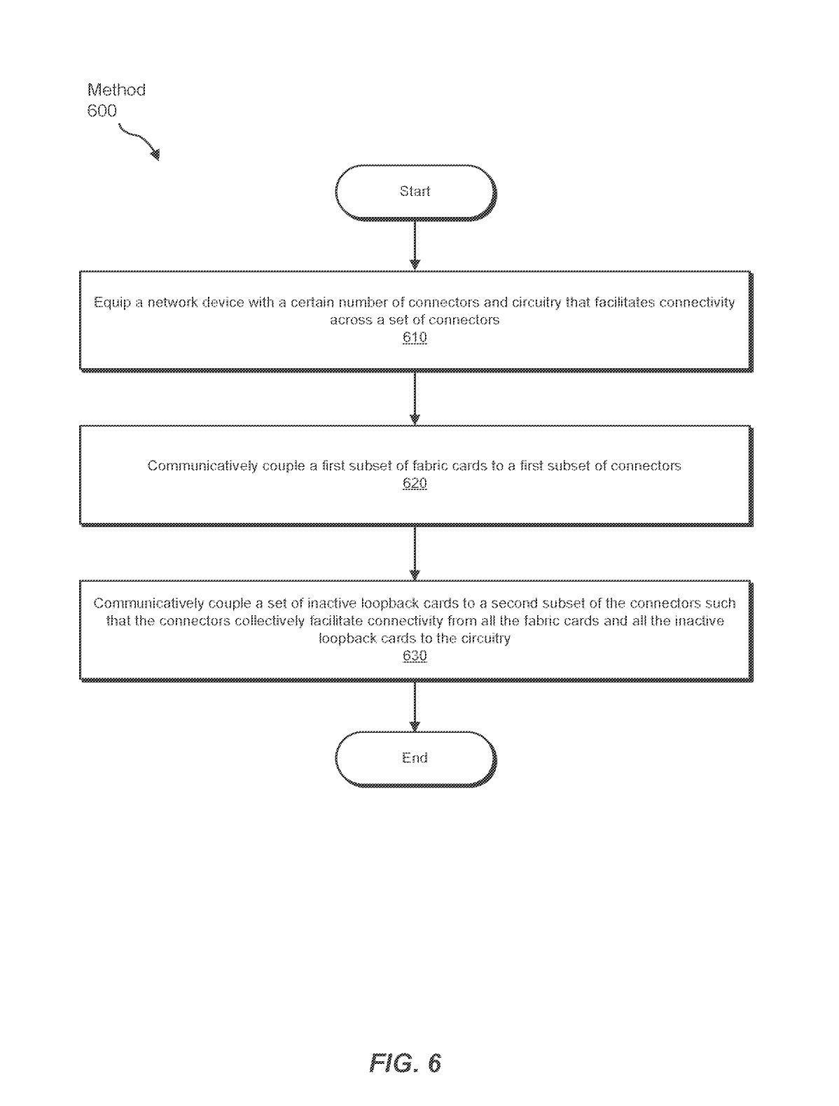

The following will provide, with reference to FIGS. 1-5, detailed descriptions of an exemplary apparatuses, systems, and corresponding implementations and configurations that facilitate and/or support reducing costs and power consumption in network fabrics. In addition, the following will provide, with reference to FIG. 6, examples of methods for reducing costs and power consumption in network fabrics.

FIG. 1 illustrates an exemplary system 100 capable of reducing costs and power consumption in network devices. In some examples, system 100 may include and/or represent a network device 102, circuitry 104, connectors 106(1)-(N), connectors 108(1)-(N), fabric cards 112(1)-(N), and/or inactive loopback cards 110(1)-(N). In one example, network device 102 may include and/or represent connectors 106(1)-(N) and/or circuitry 104 that facilitates, supports, and/or provides connectivity across connectors 106(1)-(N) and 108(1)-(N). In this example, fabric cards 112(1)-(N) may be communicatively coupled to connectors 106(1)-(N), respectively. Additionally or alternatively, inactive loopback cards 110(1)-(N) may be communicatively coupled to connectors 108(1)-(N), respectively.

In some examples, connectors 106(1)-(N) and 108(1)-(N) may collectively facilitate, support, and/or provide connectivity from all of fabric cards 112(1)-(N) and all of inactive loopback cards 110(1)-(N) to circuitry 104. In one example, network device 102 may be programmed and/or configured to achieve a certain backplane bandwidth based at least in part on a configuration requirement of one or more of fabric cards 112(1)-(N). For example, different combinations of the numbers of fabric cards 112(1)-(N) and inactive loopback cards 110(1)-(N) may constitute and/or represent different deployments of a network fabric.

In some examples, a chassis fabric backplane may be designed and/or configured for the highest density line cards (e.g., line cards that incorporate the maximum number of ASICs supported by a network fabric). Additionally or alternatively, the chassis fabric backplane may be designed and/or configured for the maximum number of line cards (e.g., all line card slots in the chassis are housing and/or are occupied by line cards). Accordingly, the chassis fabric backplane may be designed and/or configured to facilitate, support, and/or provide the maximum backplane capacity.

Some deployments may include and/or represent a certain number fabric cards that are communicatively coupled to connectors 106(1)-(N) but are not communicatively coupled to connectors 108(1)-(N). Such deployments may be unable to achieve and/or provide the full backplane bandwidth across the network fabric. connectors 108

In some examples, line cards may be considered and/or deemed high-density and/or low-density relative to one another on a given platform and/or fabric model. In other words, a line card that is considered high-density on one platform or fabric model may be considered low-density on another platform or fabric model. In one example, on a given fabric model, a line card equipped with a single packet forwarding engine (PFE) ASIC and eighteen connectors may be considered and/or deemed low-density, and another line card equipped with three PFE ASICs and fifty-four connectors may be considered and/or deemed high-density. In an additional example, on a different fabric model, a line card equipped with five PFE ASICs and thirty-two connectors may be considered and/or deemed low-density, and another line card equipped with ten PFE ASICs and sixty-four connectors may be considered and/or deemed high- density.

In some examples, a certain deployment may offer and/or provide sufficient backplane bandwidth for a given application. In one example, this deployment may involve and/or represent less fabric cards than slots and/or connectors available on a chassis. In this example, to enable functionality across the network fabric despite less fabric cards, this deployment may involve installing inactive loopback fabric cards in the remaining empty slots and/or connectors on the chassis. Accordingly, all the chassis' slots may house and/or be occupied by fabric cards and/or inactive loopback fabric cards.

In some examples, inactive loopback cards 110(1)-(N) communicatively coupled to connectors 108(1)-(N) may be configured to route, relay, and/or forward traffic through fabric cards 112(1)-(N) communicatively coupled to connectors 106(1)-(N). In one example, all the slots and/or connectors on network device 102 may be communicatively coupled to a fabric card (e.g., a switch interface board, a switch fabric board, etc.) or an inactive loopback fabric card or device. Accordingly, the combination of fabric cards 112(1)-(N) and inactive loopback cards 110(1)-(N) may collectively amount to a number or count equivalent to the number of fabric card slots or connectors on network device 102.

In some examples, system 100 may include and/or represent any type or form of physical computing device and/or network of computing devices capable of reading computer- executable instructions and/or handling network traffic. In one example, system 100 may include and/or represent some or all of a network fabric and/or router system. Examples of system 100 include, without limitation, network devices, routers (such as provider edge routers, hub routers, spoke routers, autonomous system boundary routers, and/or area border routers), rackmount telecommunications devices, switches, hubs, modems, bridges, repeaters, gateways (such as broadband network gateways), servers, chassis, variations or combinations of one or more of the same, and/or any other suitable systems.

In some examples, network device 102 may constitute and/or represent a hardware component and/or circuitry incorporated into system 100. In one example, network device 102 may forward, send, and/or relay traffic to remote devices via links and/or connections. In this example, network device 102 may include and/or represent a line card. Additional examples of network device 102 include, without limitation, physical interface cards (PICs), flexible PIC concentrators (FPCs), routers, switches, control boards, connector interface panels, rackmount devices, portions of one or more of the same, combinations or variations of one or more of the same, and/or any other suitable network device.

In some examples, inactive loopback cards 110(1)-(N) may forward, pass, and/or relay signals or traffic to or through fabric cards 112(1)-(N) installed in the network fabric. In one example, inactive loopback cards 110(1)-(N) may be communicatively coupled to unused connectors and/or slots intended and/or dimensioned for one of fabric cards 112(1)-(N) on network device 102. In some examples, circuitry 104 may include and/or represent one or more ASICs and/or PFEs. In one example, circuitry 104 may constitute one or more PFE ASICs of the forwarding plane on network device 102.

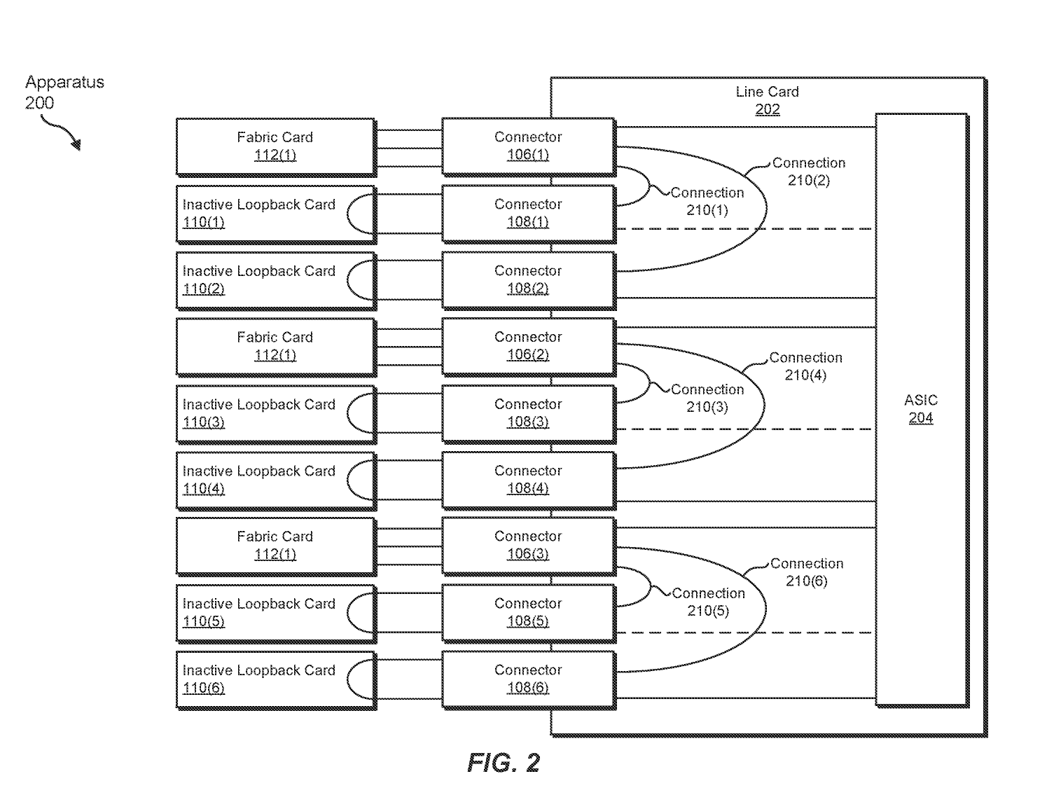

FIG. 2 illustrates an exemplary apparatus 200 capable of reducing costs and power consumption in network devices. In some examples, apparatus 200 may include and/or represent certain mechanisms, devices, components, and/or features that perform and/or provide functionalities that are similar and/or identical to those described above in connection with FIG. 1. In one example, apparatus 200 may include and/or represent a line card 202, an ASIC 204, connectors 106(1)-(3), connectors 108(1)-(6), fabric cards 112(1)-(3), inactive loopback cards 110(1)-(6), and/or connections 210(1)-(6).

In some examples, line card 202 may be equipped with an ASIC 204, connectors 106(1)-(3), and/or connectors 108(1)-(6). In one example, fabric card 112(1) may be communicatively coupled to connector 106(1), and fabric card 112(2) may be communicatively coupled to connector 106(2). Additionally or alternatively, fabric card 112(3) may be communicatively coupled to connector 106(3).

In some examples, inactive loopback card 110(1) may be communicatively coupled to connector 108(1), and inactive loopback card 110(2) may be communicatively coupled to connector 108(2). In one example, inactive loopback card 110(3) may be communicatively coupled to connector 108(3), and inactive loopback card 110(4) may be communicatively coupled to connector 108(4). Additionally or alternatively, inactive loopback card 110(5) may be communicatively coupled to connector 108(5), and inactive loopback card 110(6) may be communicatively coupled to connector 108(6).

In some examples, line card 202 may include and/or represent connections 210(1)-(6) that communicatively couple connectors 106(1)-(3) to connectors 108(1)-(6), respectively. For example, connection 210(1) may communicatively couple connector 106(1) to connector 108(1), and connection 210(2) may communicatively couple connector 106(1) to connector 108(2). In this example, connection 210(3) may communicatively couple connector 106(2) to connector 108(3), and connection 210(4) may communicatively couple connector 106(2) to connector 108(4). Additionally or alternatively, connection 210(5) may communicatively couple connector 106(3) to connector 108(5), and connection 210(6) may communicatively couple connector 106(3) to connector 108(6). In certain implementations, each of connectors 106(1)-(3) and 108(1)-(6) may be communicatively coupled to ASIC 204 of line card 202.

In some examples, inactive loopback cards 110(1)-(6) may merely return and/or loop traffic back to connectors 108(1)-(6), respectively. In one example, connectors 108(1)-(2) may pass and/or forward traffic from inactive loopback cards 110(1)-(2), respectively, to fabric card 112(1) via connections 210(1)-(2) and connector 106(1). Additionally or alternatively, connectors 108(3)-(4) may pass and/or forward traffic from inactive loopback cards 110(3)-(4), respectively, to fabric card 112(2) via connections 210(3)-(4) and connector 106(2). Similarly, connectors 108(5)-(6) may pass and/or forward traffic from inactive loopback cards 110(5)-(6), respectively, to fabric card 112(3) via connections 210(5)-(6) and connector 106(3).

In some examples, ASIC 204 may forward, send, and/or relay traffic directly to fabric cards 112(1)-(3) via connectors 106(1)-(3), respectively. Additionally or alternatively, ASIC 204 may forward, send, and/or relay traffic indirectly to fabric cards 112(1)-(3) via connectors 108(1)-(6), inactive loopback cards 110(1)-(6), and/or connectors 106(1)-(3).

In some examples, fabric cards 112(1)-(3) may forward, send, and/or relay traffic directly to ASIC 204 via connectors 106(1)-(3), respectively. Additionally or alternatively, fabric cards 112(1)-(3) may forward, send, and/or relay traffic indirectly to ASIC 204 via connectors 106(1)-(3), inactive loopback cards 110(1)-(6), and/or connectors 108(1)-(6). Although not necessarily illustrated in this way, network device 102 and/or fabric cards 112(1)- (3) may be communicatively coupled to additional network devices (e.g., nodes, hops, etc.) that carry the traffic further through the network and/or connect to additional networks.

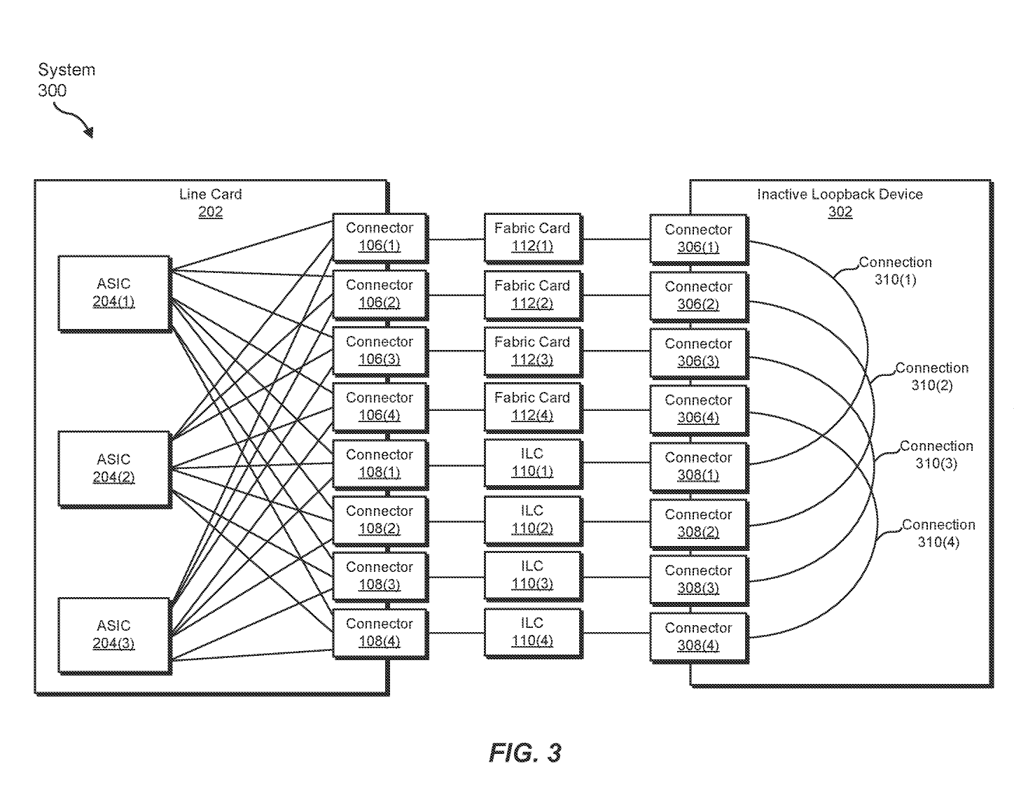

FIG. 3 illustrates an exemplary system 300 capable of reducing costs and power consumption in network devices. In some examples, system 300 may include and/or represent certain mechanisms, devices, components, and/or features that perform and/or provide functionalities that are similar and/or identical to those described above in connection with either FIG. 1 or FIG. 2. In one example, system 300 may include and/or represent line card 202, ASICs 204(1)-(3), connectors 106(1)-(4), connectors 108(1)-(4), fabric cards 112(1)-(4), inactive loopback cards (ILCs) 110(1)-(4), an inactive loopback device 302, connectors 306(1)-(4), connectors 308(1)-(4), and/or connections 310(1)-(4).

In some examples, line card 202 may be equipped with ASICs 204(1), 204(2), and 204(3), connectors 106(1)-(4), and/or connectors 108(1)-(4). Additionally or alternatively, inactive loopback device 302 may be equipped with connectors 306(1)-(4), connectors 308(1)- (4), and/or connections 310(1)-(4).

In some examples, fabric card 112(1) may be communicatively coupled to connector 106(1) and/or connector 306(1), and fabric card 112(2) may be communicatively coupled to connector 106(2) and/or connector 306(2). In one example, fabric card 112(3) may be communicatively coupled to connector 106(3) and/or connector 306(3), and fabric card 112(4) may be communicatively coupled to connector 106(4) and/or connector 306(4). In this example, ILC 110(1) may be communicatively coupled to connector 108(1) and/or connector 308(1), and ILC 110(2) may be communicatively coupled to connector 108(2) and/or connector 308(2). Additionally or alternatively, ILC 110(3) may be communicatively coupled to connector 108(3) and/or connector 308(3), and ILC 110(4) may be communicatively coupled to connector 108(4) and/or connector 308(4).

In some examples, connection 310(1) may communicatively couple connector 306(1) and connector 308(1) to one another, and connection 310(2) may communicatively couple connector 306(2) and connector 308(2) to one another. In one example, connection 310(3) may communicatively couple connector 306(3) and connector 308(3) to one another, and connection 310(4) may communicatively couple connector 306(4) and connector 308(4) to one another. In certain implementations, inactive loopback device 302 may be installed in an unused port and/or slot intended and/or dimensioned for one of a line card on a network device.

In some examples, ASICs 204(1)-(3) may forward, send, and/or relay traffic directly to fabric cards 112(1)-(4) via connectors 106(1)-(4), respectively. Additionally or alternatively, ASICs 204(1)-(3) may forward, send, and/or relay traffic indirectly to fabric cards 112(1)-(4) via connectors 108(1)-(4), ILCs 110(1)-(4), connectors 308(1)-(4), and/or connectors 306(1)-(4).

In some examples, fabric cards 112(1)-(4) may forward, send, and/or relay traffic directly to ASICs 204(1)-(3) via connectors 106(1)-(4), respectively. Additionally or alternatively, fabric cards 112(1)-(4) may forward, send, and/or relay traffic indirectly to ASICs 204(1)-(3) via connectors 306(1)-(4), connectors 308(1)-(4), ILCs 110(1)-(4), and/or connectors 108(1)-(4).

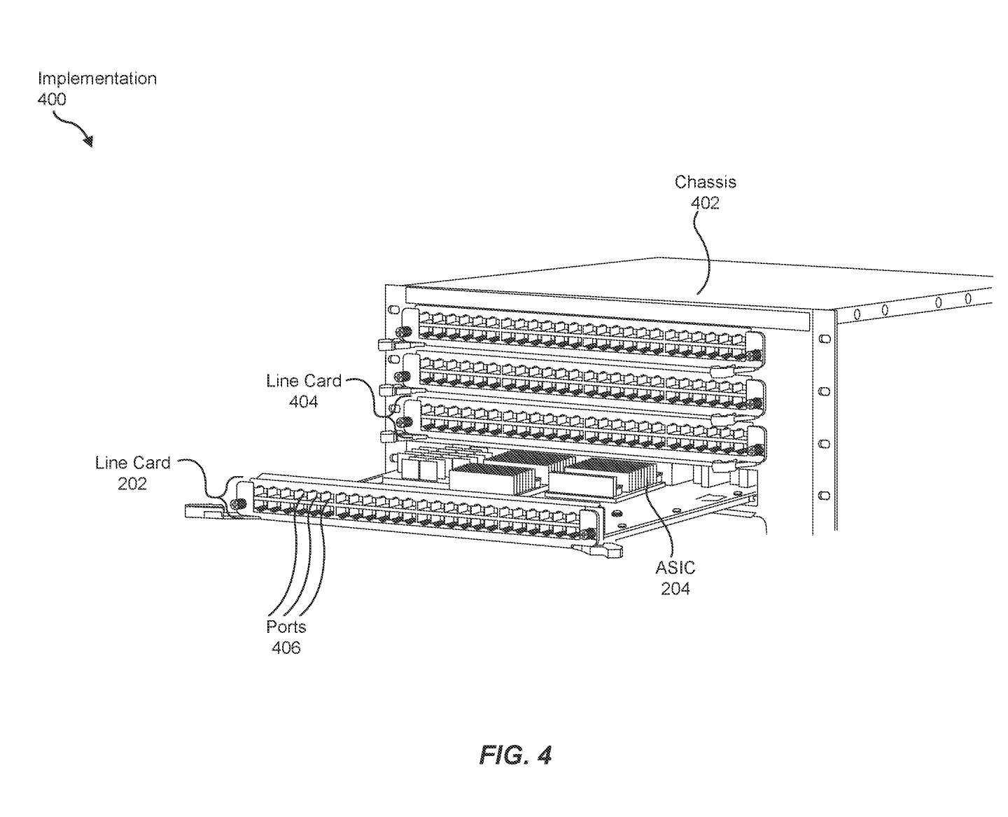

FIG. 4 illustrates an exemplary implementation 400 of a system that facilitates and/or supports reducing costs and power consumption in network devices. In some examples, implementation 400 may include and/or involve certain mechanisms, devices, components, and/or features that perform and/or provide functionalities that are similar and/or identical to those described above in connection with any of FIGS. 1-3. As illustrated in FIG. 4, implementation 400 may include and/or involve a chassis 402 equipped with slots for network devices (e.g., line cards) equipped with connectors for fabric cards toward the backplane.

In some examples, line card 202 may be installed in and/or operating in one slot of chassis 402. Additionally or alternatively, a line card 404 may be installed in and/or operating in another slot of chassis 402. In one example, one or more of inactive loopback devices (e.g., inactive loopback line cards) may be installed in and/or operating in a further slot of chassis 402. In certain implementations, one or more fabric cards may be installed in and/or operating in an additional slot of chassis 402. In certain implementations, line card 202 may be equipped with ports 406 dimensioned to house optical transceiver modules.

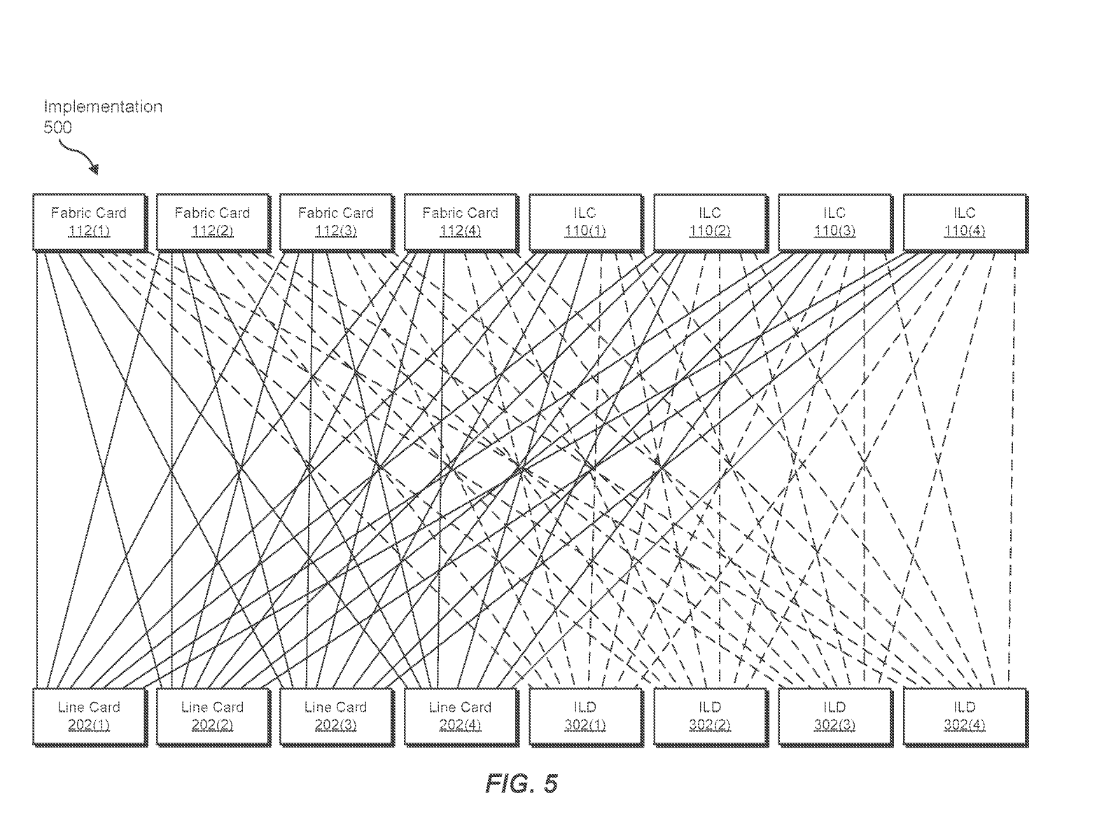

FIG. 5 illustrates an exemplary implementation 500 of a system that facilitates and/or supports reducing costs and power consumption in network devices. In some examples, implementation 500 may include and/or involve certain mechanisms, devices, components, and/or features that perform and/or provide functionalities that are similar and/or identical to those described above in connection with any of FIGS. 1-4. As illustrated in FIG. 5, implementation 500 may include and/or involve line cards 202(1)-(4), inactive loopback devices (ILDs) 302(1)-(4), fabric cards 112(1)-(4), and/or inactive loopback cards (ILCs) 110(1)-(4).

In some examples, each of line cards 202(1)-(4) may be communicatively coupled to each of fabric cards 112(1)-(4) and ILCs 110(1)-(4). In one example, each of ILDs 302(1)- (4) may be communicatively coupled to each of fabric cards 112(1)-(4) and ILCs 110(1)-(4). In this example, ILCs 110(1)-(4) may forward, pass, and/or relay signals and/or traffic from line cards 202(1)-(4) to ILDs 302(1)-(4). Additionally or alternatively, ILDs 302(1)-(4) may then forward, pass, and/or relay such signals and/or traffic from ILCs 110(1)-(4) to fabric cards 112(1)-(4).

In certain implementations, some signals and/or traffic may travel and/or traverse in the opposite direction through the same paths from fabric cards 112(1)-(4) to line cards 202(1)-(4) via ILDs 302(1)-(4) and ILCs 110(1)-(4). Although not necessarily illustrated in this way, line cards 202(1)-(4) and/or fabric cards 112(1)-(4) may be communicatively coupled to additional network devices (e.g., nodes, hops, etc.) that carry the traffic further through the network and/or connect to additional networks.

In some examples, the various apparatuses, systems, and/or devices described in connection with FIGS. 1-5 may include and/or represent one or more additional mechanisms, devices, components, and/or features that are not necessarily illustrated and/or labeled in FIGS. 1-5. For example, any of the apparatuses, systems, and/or devices in FIGS. 1-5 may also include and/or represent additional analog and/or digital circuitry, onboard logic, transistors, antennas, resistors, capacitors, diodes, inductors, switches, registers, flipflops, connections, traces, buses, semiconductor (e.g., silicon) devices and/or structures, processing devices, storage devices, circuit boards, packages, substrates, housings, attachment mechanisms, springs, heat-mitigation devices, cages, network devices, field-replaceable units, combinations or variations of one or more of the same, and/or any other suitable components.

FIG. 6 is a flow diagram of an exemplary computer-implemented method 600 for reducing costs and power consumption in network fabrics. In one example, the steps shown in FIG. 6 may be achieved and/or accomplished by a computing equipment manufacturer or subcontractor that assembles and/or manufactures the apparatuses, systems, and/or devices described herein. Additionally or alternatively, the steps shown in FIG. 6 may incorporate and/or involve certain sub-steps and/or variations consistent with the descriptions provided above in connection with FIGS. 1-5.

FIG. 6 is a flow diagram of an exemplary method 600 for reducing costs and power consumption in network fabrics. Method 600 may include the step of equipping a network device with a certain number of connectors and circuitry that facilitates connectivity across a set of connectors (610). Step 610 may be performed in a variety of ways, including any of those described above in connection with FIGS. 1-5. For example, a computing equipment manufacturer or subcontractor may equip and/or assemble a network device with a certain number of connectors and circuitry that facilitates connectivity across a set of connectors.

Method 600 may also include the step of communicatively coupling a set of fabric cards to a first subset of the connectors (620). Step 620 may be performed in a variety of ways, including any of those described above in connection with FIGS. 1-5. For example, the computing equipment manufacturer or subcontractor may communicatively couple a set of fabric cards to a first subset of the connectors.

Method 600 may also include the step of installing a set of inactive loopback cards in a second subset of the connectors such that the connectors collectively facilitate connectivity from all the fabric cards and all the inactive loopback cards to the circuitry (630). Step 630 may be performed in a variety of ways, including any of those described above in connection with FIGS. 1-5. For example, the computing equipment manufacturer or subcontractor may install and/or insert a set of inactive loopback cards in a second subset of the connectors such that the connectors collectively facilitate connectivity from all the fabric cards and all the inactive loopback cards to the circuitry.

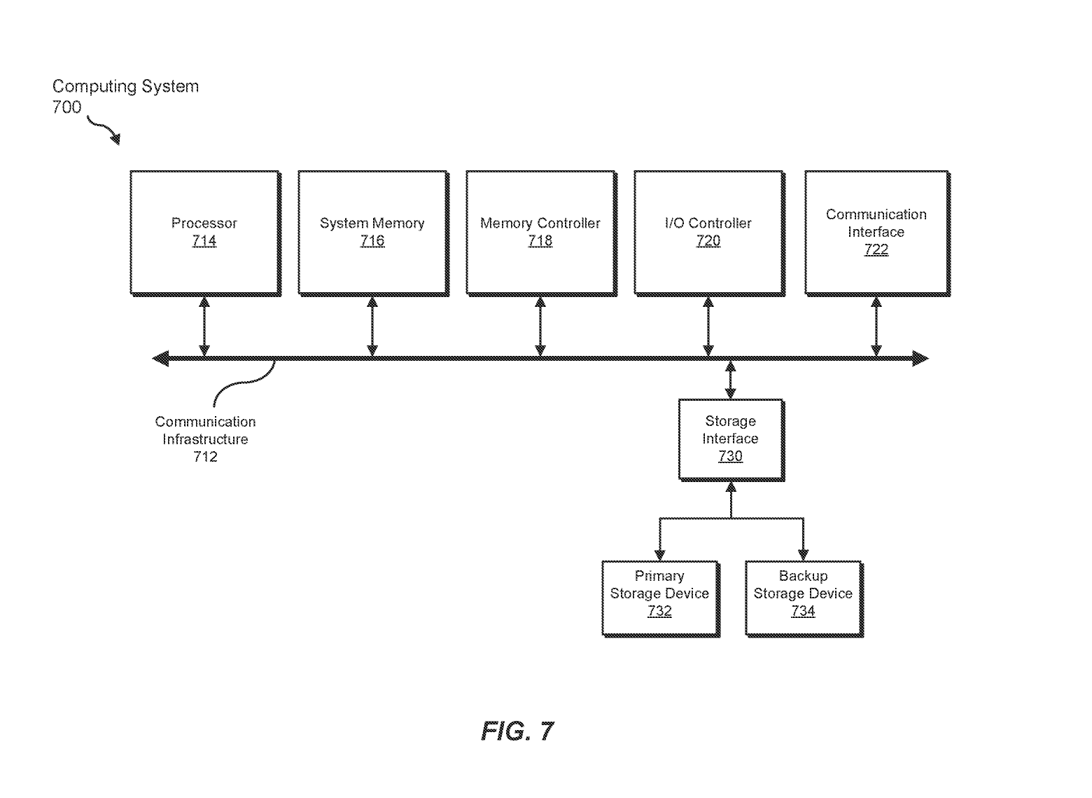

FIG. 7 is a block diagram of an exemplary computing system 700 capable of implementing and/or being used in connection with one or more of the embodiments described and/or illustrated herein. In some embodiments, all or a portion of computing system 700 may perform and/or be a means for performing, either alone or in combination with other elements, one or more of the steps described in connection with FIG. 6. All or a portion of computing system 700 may also perform and/or be a means for performing and/or implementing any other steps, methods, or processes described and/or illustrated herein. In one example, computing system 700 may include and/or store all or a portion of the apparatuses, systems, and/or implementations described in connection with FIGS. 1-5.

Computing system 700 broadly represents any type or form of electrical load, including a single or multi-processor computing device or system capable of executing computer- readable instructions. Examples of computing system 700 include, without limitation, workstations, laptops, client-side terminals, servers, distributed computing systems, mobile devices, network switches, network routers (e.g., backbone routers, edge routers, core routers, mobile service routers, broadband routers, etc.), network appliances (e.g., network security appliances, network control appliances, network timing appliances, SSL VPN (Secure Sockets Layer Virtual Private Network) appliances, etc.), network controllers, gateways (e.g., service gateways, mobile packet gateways, multi-access gateways, security gateways, etc.), and/or any other type or form of computing system or device.

Computing system 700 may be programmed, configured, and/or otherwise designed to comply with one or more networking protocols. According to certain embodiments, computing system 700 may be designed to work with protocols of one or more layers of the Open Systems Interconnection (OSI) reference model, such as a physical layer protocol, a link layer protocol, a network layer protocol, a transport layer protocol, a session layer protocol, a presentation layer protocol, and/or an application layer protocol. For example, computing system 700 may include a network device configured according to a Universal Serial Bus (USB) protocol, an Institute of Electrical and Electronics Engineers (IEEE) 1394 protocol, an Ethernet protocol, a T1 protocol, a Synchronous Optical Networking (SONET) protocol, a Synchronous Digital Hierarchy (SDH) protocol, an Integrated Services Digital Network (ISDN) protocol, an Asynchronous Transfer Mode (ATM) protocol, a Point-to-Point Protocol (PPP), a Point-to-Point Protocol over Ethernet (PPPoE), a Point-to-Point Protocol over ATM (PPPoA), a Bluetooth protocol, an IEEE 802.XX protocol, a frame relay protocol, a token ring protocol, a spanning tree protocol, and/or any other suitable protocol.

Computing system 700 may include various network and/or computing components. For example, computing system 700 may include at least one processor 714 and a system memory 716. Processor 714 generally represents any type or form of processing unit capable of processing data or interpreting and executing instructions. For example, processor 714 may represent an application-specific integrated circuit (ASIC), a system on a chip (e.g., a network processor), a hardware accelerator, a general purpose processor, and/or any other suitable processing element.

Processor 714 may process data according to one or more of the networking protocols discussed above. For example, processor 714 may execute or implement a portion of a protocol stack, may process packets, may perform memory operations (e.g., queuing packets for later processing), may execute end-user applications, and/or may perform any other processing tasks.

System memory 716 generally represents any type or form of volatile or non- volatile storage device or medium capable of storing data and/or other computer-readable instructions. Examples of system memory 716 include, without limitation, Random Access Memory (RAM), Read Only Memory (ROM), flash memory, or any other suitable memory device. Although not required, in certain embodiments computing system 700 may include both a volatile memory unit (such as, for example, system memory 716) and a non-volatile storage device (such as, for example, primary storage device 732, as described in detail below). System memory 716 may be implemented as shared memory and/or distributed memory in a network device. Furthermore, system memory 716 may store packets and/or other information used in networking operations.

In certain embodiments, exemplary computing system 700 may also include one or more components or elements in addition to processor 714 and system memory 716. For example, as illustrated in FIG. 7, computing system 700 may include a memory controller 718, an Input/Output (I/O) controller 720, and a communication interface 722, each of which may be interconnected via communication infrastructure 712. Communication infrastructure 712 generally represents any type or form of infrastructure capable of facilitating communication between one or more components of a computing device. Examples of communication infrastructure 712 include, without limitation, a communication bus (such as a Serial ATA (SATA), an Industry Standard Architecture (ISA), a Peripheral Component Interconnect (PCI), a PCI Express (PCIe), and/or any other suitable bus), and a network.

Memory controller 718 generally represents any type or form of device capable of handling memory or data or controlling communication between one or more components of computing system 700. For example, in certain embodiments memory controller 718 may control communication between processor 714, system memory 716, and I/O controller 720 via communication infrastructure 712. In some embodiments, memory controller 718 may include a Direct Memory Access (DMA) unit that may transfer data (e.g., packets) to or from a link adapter.

I/O controller 720 generally represents any type or form of device or module capable of coordinating and/or controlling the input and output functions of a computing device. For example, in certain embodiments I/O controller 720 may control or facilitate transfer of data between one or more elements of computing system 700, such as processor 714, system memory 716, communication interface 722, and storage interface 730.

Communication interface 722 broadly represents any type or form of communication device or adapter capable of facilitating communication between exemplary computing system 700 and one or more additional devices. For example, in certain embodiments communication interface 722 may facilitate communication between computing system 700 and a private or public network including additional computing systems. Examples of communication interface 722 include, without limitation, a link adapter, a wired network interface (such as a network interface card), a wireless network interface (such as a wireless network interface card), and any other suitable interface. In at least one embodiment, communication interface 722 may provide a direct connection to a remote server via a direct link to a network, such as the Internet. Communication interface 722 may also indirectly provide such a connection through, for example, a local area network (such as an Ethernet network), a personal area network, a wide area network, a private network (e.g., a virtual private network), a telephone or cable network, a cellular telephone connection, a satellite data connection, or any other suitable connection.

In certain embodiments, communication interface 722 may also represent a host adapter configured to facilitate communication between computing system 700 and one or more additional network or storage devices via an external bus or communications channel. Examples of host adapters include, without limitation, Small Computer System Interface (SCSI) host adapters, Universal Serial Bus (USB) host adapters, IEEE 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 722 may also enable computing system 700 to engage in distributed or remote computing. For example, communication interface 722 may receive instructions from a remote device or send instructions to a remote device for execution.

As illustrated in FIG. 7, exemplary computing system 700 may also include a primary storage device 732 and/or a backup storage device 734 coupled to communication infrastructure 712 via a storage interface 730. Storage devices 732 and 734 generally represent any type or form of storage device or medium capable of storing data and/or other computer- readable instructions. For example, storage devices 732 and 734 may represent a magnetic disk drive (e.g., a so-called hard drive), a solid state drive, a floppy disk drive, a magnetic tape drive, an optical disk drive, a flash drive, or the like. Storage interface 730 generally represents any type or form of interface or device for transferring data between storage devices 732 and 734 and other components of computing system 700.

In certain embodiments, storage devices 732 and 734 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 732 and 734 may also include other similar structures or devices for allowing computer software, data, or other computer-readable instructions to be loaded into computing system 700. For example, storage devices 732 and 734 may be configured to read and write software, data, or other computer-readable information. Storage devices 732 and 734 may be a part of computing system 700 or may be separate devices accessed through other interface systems.

Many other devices or subsystems may be connected to computing system 700. Conversely, all of the components and devices illustrated in FIG. 7 need not be present to practice the embodiments described and/or illustrated herein. The devices and subsystems referenced above may also be interconnected in different ways from those shown in FIG. 7. Computing system 700 may also employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The term "computer-readable medium" generally refers to any form of device, carrier, or medium capable of storing or carrying computer-readable instructions. Examples of computer- readable media include, without limitation, transmission-type media, such as carrier waves, and non-transitory-type media, such as magnetic-storage media (e.g., hard disk drives and floppy disks), optical-storage media (e.g., Compact Disks (CDs) and Digital Video Disks (DVDs)), electronic-storage media (e.g., solid-state drives and flash media), and other distribution systems.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

In some examples, all or a portion of system 100 in FIG. 1 may represent portions of a cloud-computing or network-based environment. Cloud-computing and network- based environments may provide various services and applications via the Internet. These cloud- computing and network-based services (e.g., software as a service, platform as a service, infrastructure as a service, etc.) may be accessible through a web browser or other remote interface. Various functions described herein may also provide network switching capabilities, gateway access capabilities, network security functions, content caching and delivery services for a network, network control services, and/or and other networking functionality.

In addition, one or more of the modules may transform data, physical devices, and/or representations of physical devices from one form to another. Additionally or alternatively, one or more of the modules may transform a processor, volatile memory, non- volatile memory, and/or any other portion of a physical computing device from one form to another by executing on the computing device, storing data on the computing device, and/or otherwise interacting with the computing device.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms "connected to" and "coupled to" (and their derivatives), as used in the specification and claims, are to be construed as permitting both direct and indirect (i.e., via other elements or components) connection. In addition, the terms "a" or "an," as used in the specification and claims, are to be construed as meaning "at least one of." Finally, for ease of use, the terms "including" and "having" (and their derivatives), as used in the specification and claims, are interchangeable with and have the same meaning as the word "comprising."

What is claimed is:

1. A system comprising:
a network device that:is equipped with a certain number of connectors; and
comprises circuitry that facilitates connectivity across the connectors;
a set of fabric cards communicatively coupled to a first subset of the connectors; and
a set of inactive loopback cards communicatively coupled to a second subset of the connectors, wherein the connectors collectively facilitate connectivity from all the fabric cards and all the inactive loopback cards to the circuitry.

2. The system of claim 1, wherein the network device is programmed to achieve a certain backplane bandwidth based at least in part on a configuration requirement of one of the fabric cards.

3. The system of claim 1, wherein the inactive loopback cards communicatively coupled to the second subset of connectors are configured to route traffic through the fabric cards communicatively coupled to the first subset of connectors.

4. The system of claim 1, wherein:
the network device comprises a line card;
the circuitry comprises a single application-specific integrated circuit (ASIC).

5. The system of claim 1, wherein:
the network device comprises a line card;
the circuitry comprises a plurality of application-specific integrated circuits (ASICs).

6. The system of claim 1, wherein the set of fabric cards and the set of inactive loopback cards collectively amount to a number equivalent to the certain number of connectors.

7. The system of claim 1, wherein the network device comprises a set of connections that communicatively couple some of the connectors to one another.

8. The system of claim 1, further comprising an inactive loopback device that:
is equipped with a set of additional connectors;
is communicatively coupled to the network device via the fabric cards and the inactive loopback cards; and
comprises a set of connections that communicatively couple some of the additional connectors to one another.

9. The system of claim 8, wherein the set of inactive loopback cards relay traffic received from the set of fabric cards by the inactive loopback device to the network device via the connections.

10. The system of claim 1, further comprising a chassis equipped with a set of slots, wherein:the network device is installed in one of the slots; andthe inactive loopback device is installed in another one of the slots.

11. The system of claim 10, wherein:
the set of fabric cards are each communicatively coupled to both the network device and the inactive loopback device; and
the set of inactive loopback cards:
are communicatively coupled to both the network device and the inactive loopback device;
is configured to relay traffic received from the network device to any of the fabric cards via the inactive loopback device; and
is configured to relay traffic received from the any of the fabric cards to the network device via the inactive loopback device.

12. An apparatus comprising:
a line card that: is equipped with a certain number of connectors; and
comprises at least one application-specific integrated circuit (ASIC) that facilitates connectivity across the connectors;
a set of fabric cards communicatively coupled to a first subset of the connectors; and
a set of inactive loopback cards communicatively coupled to a second subset of the connectors, wherein the connectors collectively facilitate connectivity from all the fabric cards and all the inactive loopback cards to the ASIC.

13. The apparatus of claim 12, wherein the line card is programmed to achieve a certain backplane bandwidth based at least in part on a configuration requirement of one of the fabric cards.

14. The apparatus of claim 12, wherein the inactive loopback cards communicatively coupled to the second subset of connectors are configured to route traffic through the fabric cards communicatively coupled to the first subset of connectors.

15. The apparatus of claim 12, wherein the set of fabric cards and the set of inactive loopback cards collectively amount to a number equivalent to the certain number of connectors.

16. The apparatus of claim 12, wherein the line card comprises a set of connections that communicatively couple some of the connectors to one another.

17. The apparatus of claim 12, further comprising an inactive loopback device that:
is equipped with a set of additional connectors;
is communicatively coupled to the line card via the fabric cards and the inactive loopback cards; and
comprises a set of connections that communicatively couple some of the additional connectors to one another.

18. The apparatus of claim 17, wherein the set of inactive loopback cards relay traffic received from the set of fabric cards by the inactive loopback device to the line card via the connections.

19. The apparatus of claim 17, wherein:
the set of fabric cards are each communicatively coupled to both the line card and the inactive loopback device; and
the set of inactive loopback cards:are communicatively coupled to both the line card and the inactive loopback device;is configured to relay traffic received from the line card to any of the fabric cards via the inactive loopback device; andis configured to relay traffic received from the any of the fabric cards to the line card via the inactive loopback device, further comprising a chassis equipped with a set of slots, wherein:the line card is installed in one of the slots; andthe inactive loopback device is installed in another one of the slots.

20. A method comprising:
equipping a network device with a certain number of connectors and circuitry that facilitates connectivity across the connectors;
communicatively coupling a set of fabric cards to a first subset of the connectors; and
communicatively coupling a set of inactive loopback cards to a second subset of the connectors such that the connectors collectively facilitate connectivity from all the fabric cards and all the inactive loopback cards to the circuitry.
